(19) United States
(12) Patent Application Publication
(10) Pub. No.: US 2007/0216568 A1
(43) Pub. Date: Sep. 20, 2007

(54) Fmcw Radar with Restricted Emission Time to Avoid Aliasing Effects

(76) Inventor: Martin Kunert, Neutraubling (DE)

Correspondence Address: MORRISON & FOERSTER LLP, 1650 TYSONS BOULEVARD, SUITE 400, MCLEAN, VA, 22102, US

(21) Appl. No.: 10/496,960

(22) PCT Filed: Nov. 20, 2002
(86) PCT No.: PCT/DE02/04274

§ 371 Date: Nov. 27, 2006

(30) Foreign Application Priority Data
Nov. 28, 2001 (DE) 10158269.2

(51) Int. Cl. G01S 13/58

(52) U.S. Cl. 342/107

(57) ABSTRACT

The invention relates to a radar system comprising an evaluation device (10) which determines the speed and/or the distance of at least one object to be located, on the basis of a spectral analysis of a measuring signal (h(t)) consisting of an emission signal and a reception signal (R(t)). According to the invention, means (12) are used to limit the emission time (τ_{a on}) of the emission signal (T(t)) in order to avoid aliasing effects.

The invention relates to a radar system with an evaluation device which, on the basis of a spectral analysis of a measuring signal formed from an emission signal and a reception signal, determines the speed and/or distance of at least: one object to be located.

Areas of application particularly suitable for radar technology include automobiles and industry for the location of objects, with the possibility of registering the distance and/or speed and/or physical composition and/or presence of one or more objects. The functionality and measuring accuracy of radar systems as well as the cost of such systems depend substantially on the modulation method employed and on the associated radar signal processing, pulse modulation and frequency modulation being particularly widely employed methods.

With the pulse modulation method or, as the case may be, pulse propagation time method a short radar pulse is emitted toward the object being measured and, after a specific propagation time, is received again as a reflected pulse. The radar pulse's propagation time is directly proportional to the distance from the object being measured. In order to eliminate the ambiguities associated with the pulse propagation time method due to the ambiguity function it is already known how to set the measuring repetition frequency at a level adequately high for reflected signals only to be received during the current measuring cycle, with all the signals originating from the preceding measuring cycle being sufficiently weakened. Following a physical principle, this weakening is due to propagation-time-dependent distance attenuation which decreases at 1/distance². At a measuring cycle frequency of, for instance, 10 kHz the measuring interval is 100 μs. So that a pulse signal from the preceding measuring cycle can be registered in the succeeding measuring cycle, the signal must have an additional propagation time of 100 μs, corresponding to a distance of approximately 30 km. The receive amplitude of “long-distance runners” of this type differs by several orders of magnitude from the reflection amplitudes of targets in the range of a few meters and is practically no longer detectable.

In the application of the FMCW (FMCW: Frequency Modulated Continuous Wave) radar principle, which is employed especially for measuring distances, a frequency-modulated radar signal is emitted which is received phase-shifted or, as the case may be, frequency-shifted. The measured phase or, as the case may be, frequency difference, typically in the kilohertz range, is proportional to the object's distance. In the application of the FMCW method, reflection objects situated further away also, following a physical principle, produce higher frequencies. In order to eliminate the ambiguities due to the ambiguity function and to uniquely define the measuring range up to a specific distance, it is known how to cut off all frequencies above the frequency value corresponding to the specific distance, which is done with as steep an edge as possible. Higher-order filter structures are employed in particular for this purpose, for example an eighth-order Bessel low-pass filter. Targets situated at greater distances are attenuated in keeping with the filter characteristics by means of this “anti-aliasing filtering”, as it is termed, and so can no longer produce disruptions due to fold-back effects in the spectrum. To allow the continuous signals to be digitally further processed with no loss of information, it is further necessary to select the sampling-frequency as twice the filter corner frequency in accordance with Shannon's theorem. Microcontrollers and/or signal processors are generally employed for digital further processing.

The object of the invention is to develop the radar systems according to the specific type in such a way as to reduce the required amount of hardware and/or software expenditure.

Said object is achieved by means of the features of claim 1.

Advantageous embodiments and developments of the invention will emerge from the dependent claims.

The radar system according to the invention proceeds from the prior art according to the specific type in that means are provided which limit the emission time of the emission signal to avoid aliasing effects. This solution makes it possible to dispense with the anti-aliasing filter provided in the known radar systems, thereby reducing the costs. A further advantage of the solution according to the invention is that, in keeping with the predominant requirements, the sampling frequency can be varied within wide ranges since dispensing with the generally non-adjustable anti-aliasing filter eliminates coupling via Shannon's sampling theorem. Varying of the sampling frequency can be advantageously used in order, for example, to increase the resolution with a constant frequency deviation and/or constant measuring time.

By limiting the emission time of the emission signal, preferred embodiments of the radar system according to the invention furthermore make provision for generating a pulse-shaped emission signal whose emission pulse length determines the maximum measuring range. Limiting of the emission time or, as the case may be, setting of the emission pulse length can be done by, for example, power clocking the emission signal during modulation, as proposed in DE 198 03 660.4, the disclosure content of which is included here through this reference. According to the present invention—and departing from the expositions contained in the above-cited DE 198 03 660.4—the emission pulse length is, by contrast, preferably set such that a pre-specified maximum measuring range R_{πax} is maintained via the signal propagation time condition. R_{πax} here equals 2× emission pulse length/speed of light. The measuring range can thus be varied on an application-dependent basis between less than one meter and several meters or, as the case may be, 100 meters. A major departure from the known pulse propagation time method mentioned at the beginning is that signal evaluation according to the invention takes place through spectral analysis and not through measuring the propagation time of the radar pulse itself.

In particular in order to facilitate the above-mentioned application-dependent varying of the measuring range, provision is preferably further made for the emission pulse length of the emission signal to be variable.

Additional or alternative provision can advantageously be made for changing between at least two emission pulse lengths for determining the maximum measuring range. If, for example, alternate switching takes place back and forth between at least two different emission pulse lengths in the presence of a (moving) target object, the influence on the strength of the reception signal can be evaluated in order to precisely determine the maximum measuring range.

As mentioned, for all embodiments of the radar system according to the invention it is preferable for the measuring signal to be a digital measuring signal.

A further preferable provision in this regard is for the digital measuring signal to be obtained from a mixer output signal of a mixer. As applies to the invention as a whole, it is of no consequence here whether the emitting and receiving unit of the radar system according to the invention is operated monostatically or bistatically.

A further preference is for the digital measuring signal to be supplied by an analog-digital converter whose sampling frequency is variable. Varying of the sampling frequency can, as mentioned, be advantageously used in particular to increase the resolution with a. constant frequency deviation and/or constant measuring time.

Although not absolutely essential, provision is made in especially preferred embodiments of the radar system according to the invention for buffering of the mixer output signal by a sample and hold circuit before said signal is routed to the analog-digital converter, with the digitizing rate of the analog-digital converter preferably being less than or the same as the sampling rate of the sample and hold circuit.

A further preferable provision in this regard is for the sample time of the sample and hold circuit to be capable of being set independently of the emission pulse length.

As a further provision especially in this regard, the sample time of the sample and hold circuit can be delayed with respect to the emission pulse length.

Additional or alternative provision can be made for the sample time of the sample and hold circuit to be less than or the same as the emission pulse length. Delaying the sample time of the sample and hold circuit (and, where applicable, also the sample time of the analog-digital converter) makes better signal evaluation possible, owing in particular to a significant reduction in overlapping-and glitch effects.

Further provision is made in preferred embodiments of the radar system according to the invention for the input of the sample and hold circuit to be taken outside the sample time to a low-resistance operating point. This allows effective suppression of signal reflections in the high-frequency range. The low-resistance, defined operating point can be formed by, for example, virtual ground.

A provision at least for certain operating modes of the radar system according to the invention is for the emission signal to be a frequency-modulated emission signal.

It is further provided here for the frequency of the frequency-modulated emission signal to be varied at least at times, in particular for determining the distance from an object to be located. With the exception of limiting the emission time, this operating mode corresponds to the FMCW method known per se.

A provision in this regard can be for the frequency of he frequency-modulated emission signal to be continuously varied.

An alternative provision at least for certain operating modes of the radar system according to the invention can be for the frequency of the frequency-modulated emission signal to be varied in discrete frequency stages. The relevant frequency is here applied preferably both before and after the respective emission pulse stably for a minimum period of time. The discrete frequency stages can be produced by means, for example, of a simple combination of various resistance values with a capacitance, with the resistors being switched either to ground or to high-resistance, preferably by a microcontroller.

A provision of a specially preferred development of the radar system according to the invention is for the discrete frequency stages to be capable of being started up in any sequence.

It is thereby possible, for example, for the values arising after the sample and hold circuit of the analog-digital converter to be numerically sorted or, as the case may be, routed according to their current frequency value. Temporal interleaving of in each case one measuring point of an upward or, as the case may be, downward frequency ramp is a particularly effective and efficient embodiment'since both frequency ramps are accepted practically simultaneously. Starting up of the discrete frequency stages in any, which is to say in particular non-sorted sequence can generally affectively help avoid fading effects.

A provision at least for certain operating modes of the radar system according to the invention is for the frequency of the frequency-modulated emission signal to be kept constant at least at times, in particular for determining the speed of an object to be located. This method follows the Doppler radar method known per se. If the duration of the emission pulse is varied continuously or discretely within a pre-defined range, it is possible to measure the Doppler speed as a function of distance.

Because radar technology is being employed increasingly in the motorized vehicle sector, it is in many cases advantageous if provision has been made for the settable emission time to be matched to measuring ranges required in the area of motorized vehicles and to be, in particular, between 20 ns and 200 ns. An emission time of 20 ns here corresponds approximately to a measuring range von 3 m, while an emission time of 200 ns corresponds approximately to a measuring range of 30 m. The indicated range can, where necessary, be extended either upward or downward to produce measuring ranges of less than one meter up to a few hundred meters. A preference in each case is for it to be possible to switch over the emission time or, as the case may be, emission pulse length, and hence the respective distance measuring range, on an application-specific basis. In the area of motorized vehicles the radar system according to the invention has potential applications in, for example, aids to parking, pre-crash detection, and blind-angle monitoring, etcetera.

The invention is based on the knowledge that both the known FMCW systems and the known CW systems can be produced more economically with no loss in performance by dispensing with an anti-aliasing filter and employing instead emission time limitation via which the measuring range can be suitable determined.

The invention is explained in an exemplary fashion below with the aid of preferred embodiments with reference to the attached drawings.

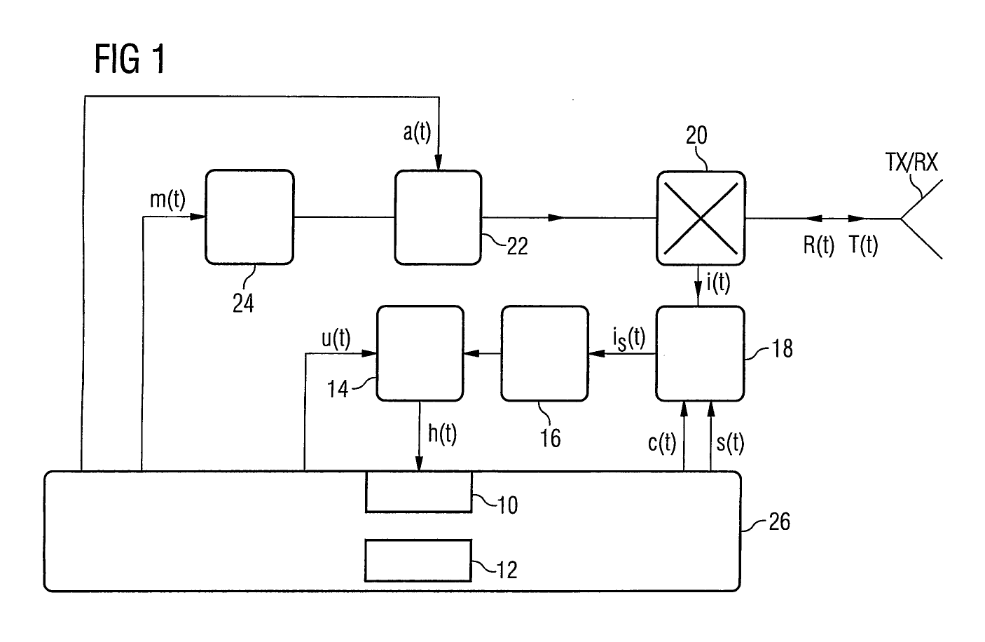

FIG. 1 is a block diagram of an embodiment of the radar system according to the invention;

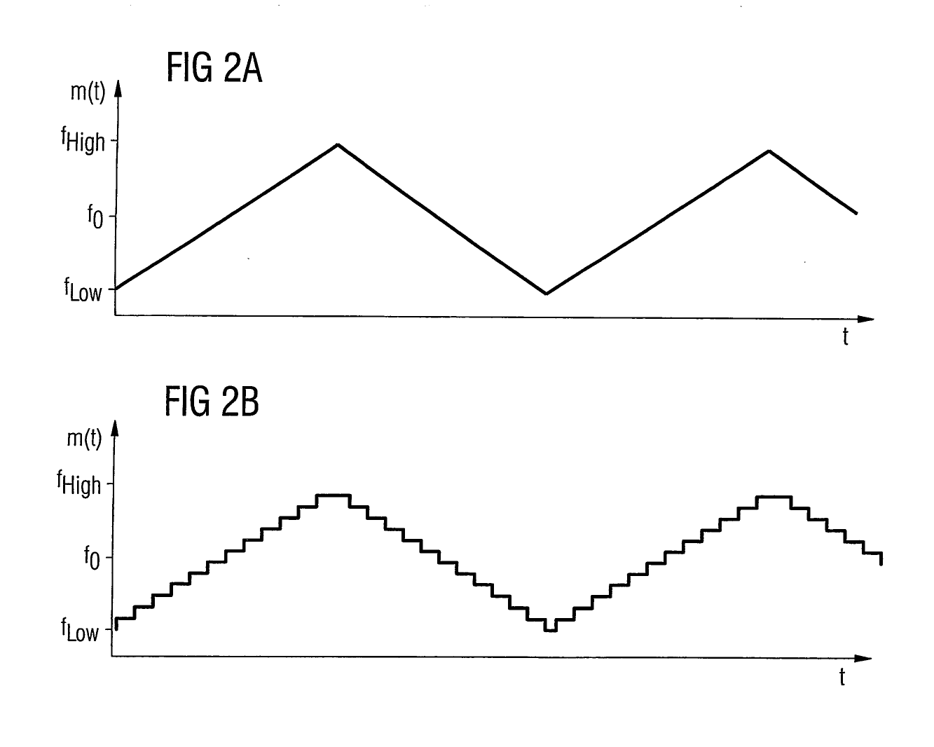

FIG. 2a shows a possible curve of continuous driving in the form of a ramp signal for the voltage-controlled oscillator;

FIG. 2b shows a possible curve of discrete driving in the form of a ramp signal for the voltage-controlled oscillator;

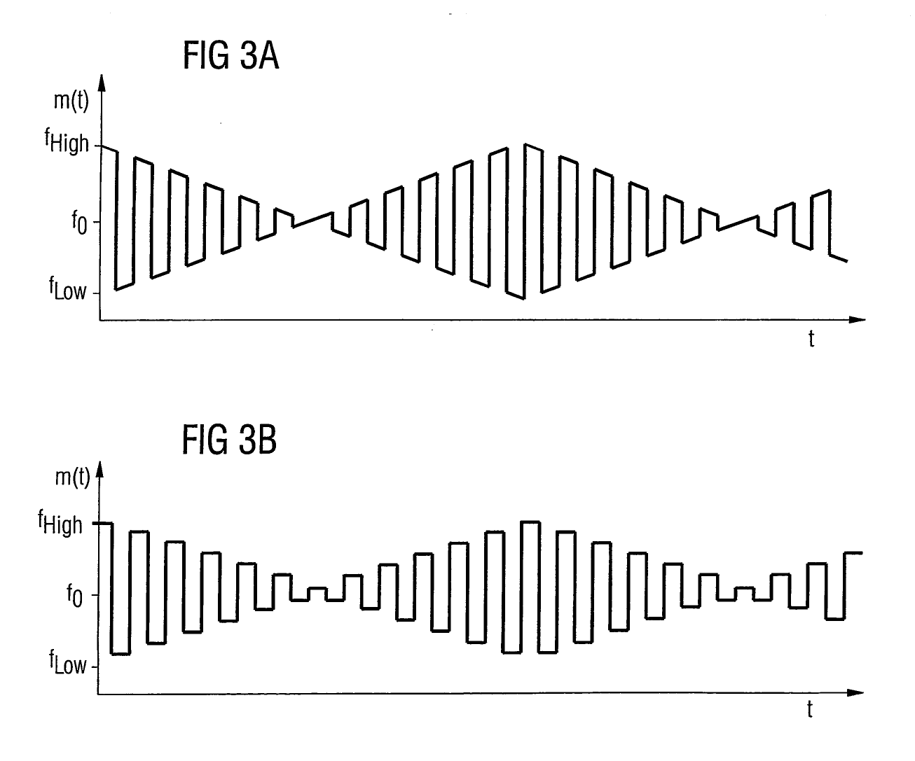

FIG. 3a shows a possible curve of continuous driving in the form of a ramp signal for the voltage-controlled oscillator, with temporal interleaving of in each case one measuring point of the upward or, as the case may be, downward frequency ramp;

FIG. 3b shows a possible curve of discrete driving in the form of a ramp signal for the voltage-controlled oscillator, with temporal interleaving of in each case one measuring point of the upward or, as the case may be, downward frequency ramp;

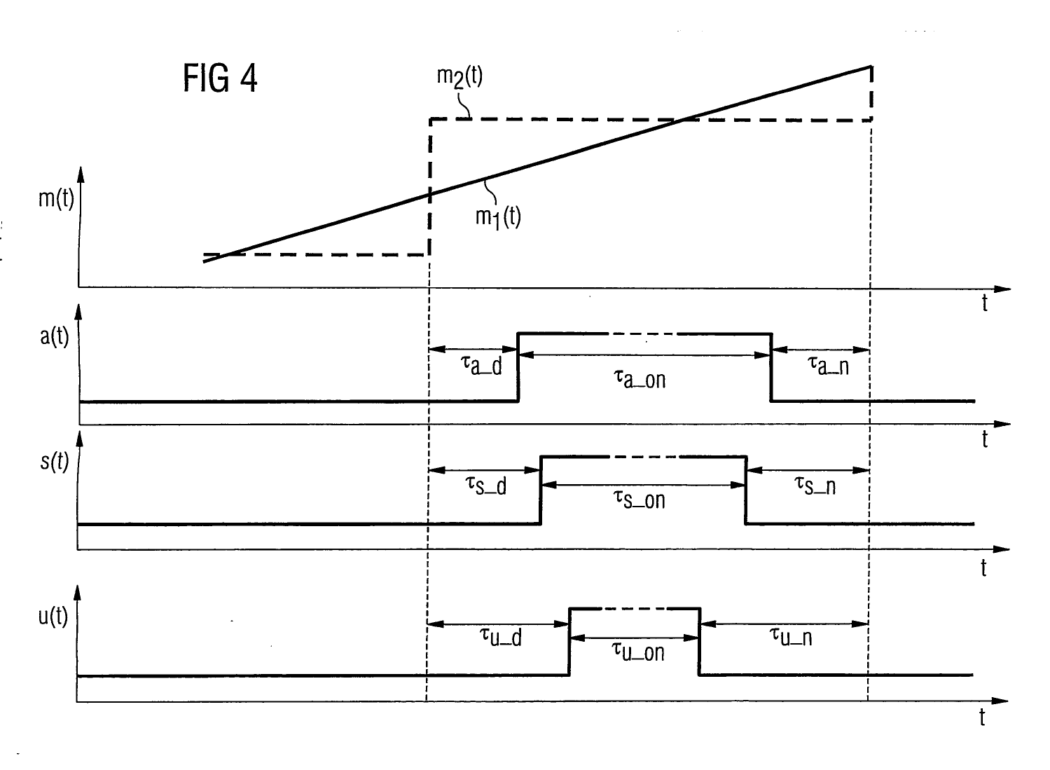

FIG. 4 shows a possible association between the drive signal for the voltage-controlled oscillator the power clock in the emission branch, the sampling signal of the sample and hold circuit in the high-frequency branch, and the trigger signal for the analog-digital converter;

FIG. 5 shows a simple embodiment of a drive circuit for the sample and hold circuit in the form of an RC variant;

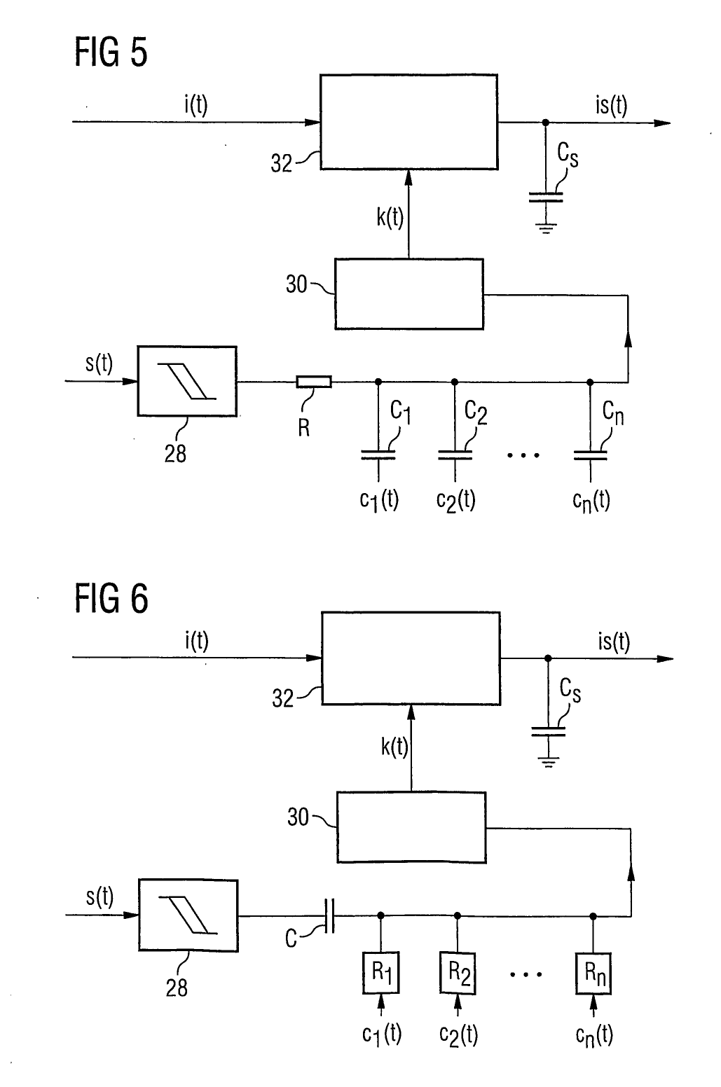

FIG. 6 shows a simple embodiment of a drive circuit for the sample and hold circuit in the form of a CR variant;

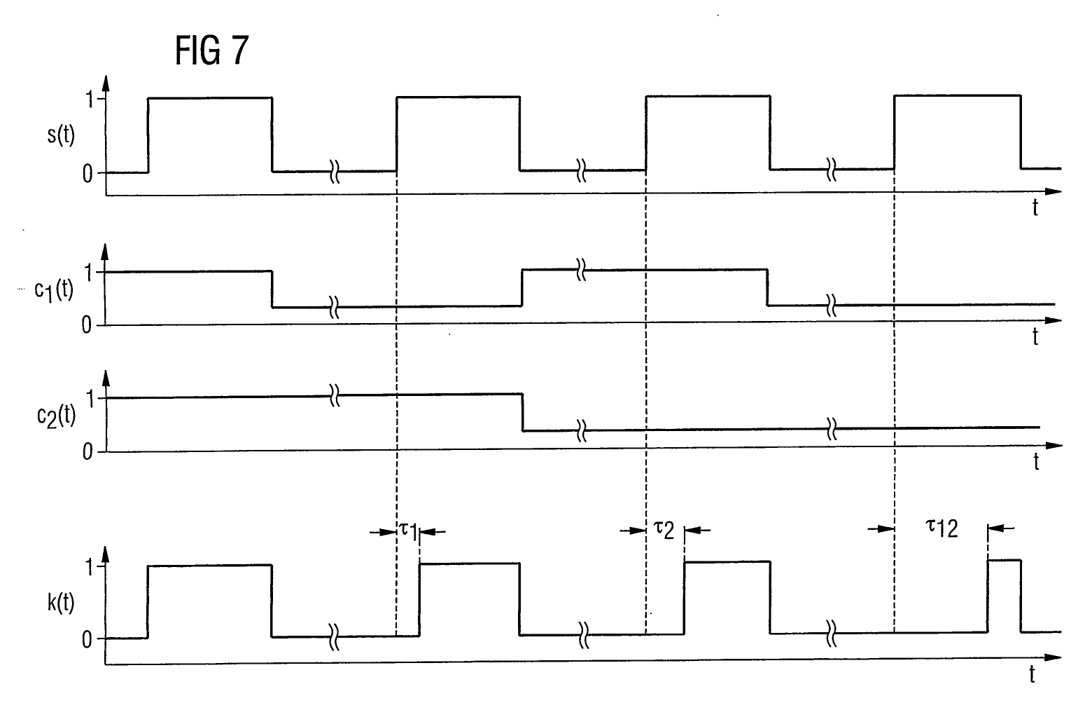

FIG. 7 shows a possible association with a variation in pulse duration produced as a function of several control signals;

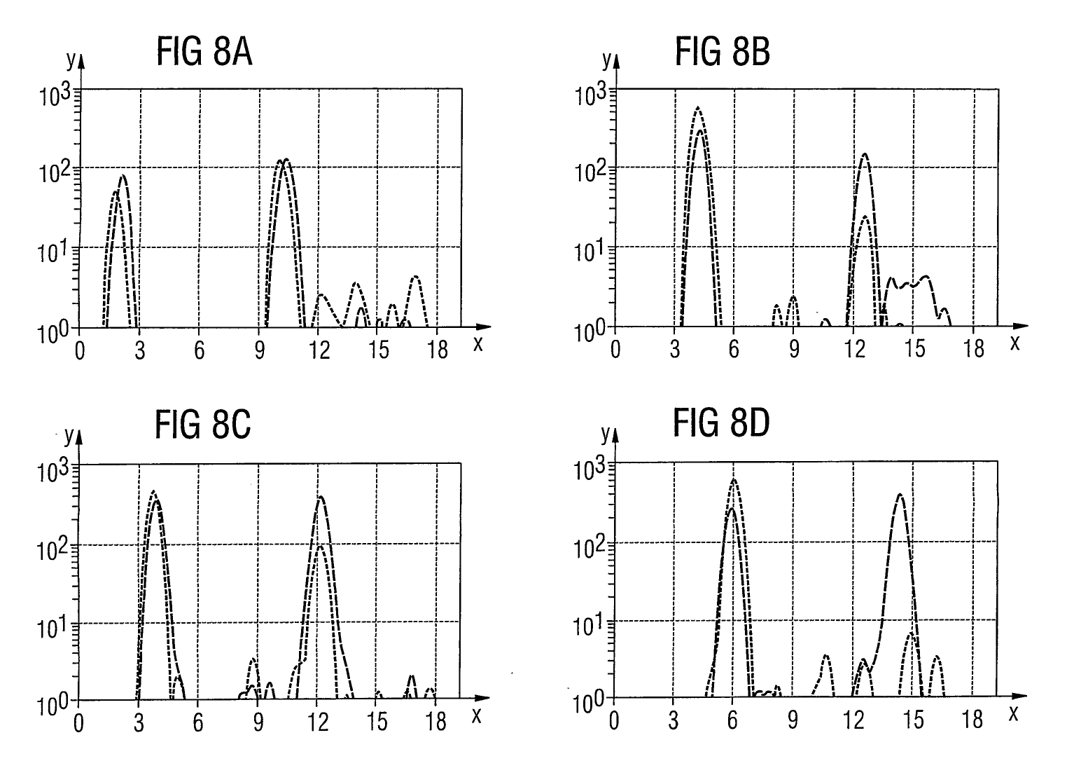

FIG. 8a shows the influence of the sampling gate time on the signal amplitude for two targets spaced approximately 8.4 m apart, with the closer target being approximately 2 m distant;

FIG. 8b shows the influence of the sampling gate time on the signal amplitude for two targets spaced approximately 8.4 m apart, with the closer target being approximately 4.5 m distant;

FIG. 8c shows the influence of the sampling gate time on the signal amplitude for two targets spaced approximately 8.4 m apart, with the closer target being approximately 4 m distant;

FIG. 8d shows the influence of the sampling gate time on the signal amplitude for two targets spaced approximately 8.4 m apart, with the closer target being approximately 6 m distant; and

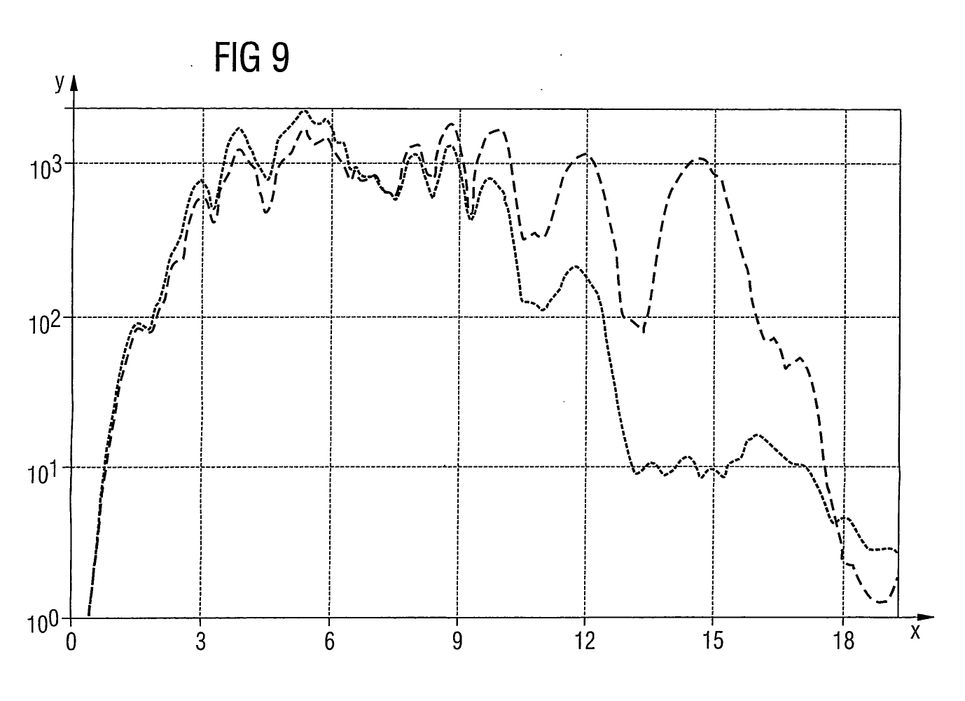

FIG. 9 shows the influence of the sampling gate time on the signal amplitude for a target with a continuously varied distance.

FIG. 1 is a block diagram of an embodiment of the radar system according to the invention. The system shown is a monostatically operated system with two-cycle sampling. A microcontroller designated overall with 26 forms both the evaluation device 10 and the means 12 for limiting the emission time τₐ_{_{—}}ₒₙ. The microcontroller 26 also performs all other control functions or, as the case may be, regulating functions. Among other things the microcontroller 26 generates a drive signal m(t), which is routed to a voltage-controlled oscillator 24, in order to generate a frequency-modulated emission signal T(t). The output of the voltage-controlled oscillator 24 is connected to the input of a switch 22 which switches the frequency-modulated emission signal T(t) through to its output if a power clock a(t) likewise generated by the microcontroller 26 is logical one. The length of time for which the power clock a(t) is logical one thus determines the emission pulse length τₐ_{_{—}}ₒₙ. The frequency-modulated emission signal T(t) switched through by the switch 22 is routed to a mixer 20 and forwarded from there to the send and receive antenna TX/RX. A reception signal R(t) reflected by one or more objects to be located is likewise routed to the mixer 20 in a manner known per se. The mixer 20 supplies a mixer output-signal i(t) which is routed to a sample and hold circuit 18 which is thus assigned to the high-frequency cycle. Several control signals, among which a drive signal c(t) and a sample signal s(t) are shown, are furthermore more routed to the sample and hold circuit 18. The mixer output signal iₛ(t) sampled by the sample and hold circuit 18 is routed to an amplifier 16 which can have, for example, an amplification factor matched to the respective measuring range. The output of the amplifier 16 is connected to an analog-digital converter 14 which supplies a digital measuring signal h(t) when a trigger signal u(t) is routed to it.

When the frequency of the frequency-modulated output signal T(t) is varied, the spectrum of the mixer output signal i(t) contains, for example, information about the distance of one or more target objects. When the frequency of the frequency-modulated emission signal T(t) is kept constant, the spectrum of the mixer output signal i(t) contains, in particular, information about the speed of an ordered object according to the Doppler radar method known per se. Although two-cycle sampling is provided in the embodiment according to FIG. 1 owing to the sample and hold circuit 18 and the other sample and hold circuit assigned to the analog-digital converter 14, the notion underlying the present invention can also be applied to embodiments in which only an analog-digital converter with one sample and hold circuit is provided. According to the invention, band limiting of the mixer output signal i(t) is performed exclusively by means of direct limiting of the emission time while the emission signal T(t) is under-going frequency modulation, so that no customarily employed anti-aliasing filter is required.

FIG. 2a shows a possible curve of continuous driving in the form of a ramp signal for the voltage-controlled oscillator and FIG. 2b shows a possible curve of discrete driving in the form of a ramp signal for the voltage-controlled oscillator. The discrete frequency stages shown in FIG. 2b are in practice very much easier to produce than the continuous frequency ramp shown in FIG. 2a.

FIG. 3a shows a possible curve of continuous driving in the form of a ramp signal for the voltage-controlled oscillator, with temporal interleaving of in each case one measuring point of the upward or, as the case may be, downward frequency ramp and FIG. 3b shows a possible curve of discrete driving in the form of a ramp signal for the voltage-controlled oscillator, with temporal interleaving of in each case one measuring point of the upward or, as the case may be, downward frequency ramp. Although the basic preference is for all (discrete) frequency stages to be capable of being started up successively in any sequence, the temporal interleaving of in each case one measuring point of the upward or, as the case may be, downward frequency ramp is a particularly effective and efficient embodiment. This is owing in particular to the fact that both frequency ramps are accepted practically simultaneously. The curves of the drive signal m(t) shown in FIGS. 3a and 3b can in particular help avoid undesired fading effects.

FIG. 4 shows a possible association between the drive signal for the voltage-controlled oscillator m(t), the power clock in the emission branch a(t), the sampling signal of the sample and hold circuit 18 in the high-frequency branch s(t), and the trigger signal for the analog-digital converter u(t). Curve m₁(t) designates the continuous frequency ramp according to FIG. 2a, while curve m₂(t) illustrates the discrete frequency ramp according to FIG. 2b. Limiting according to the invention of the emission time of the emission signal T(t) takes place via the power clock a(t), which is routed to the switch 22 shown in FIG. 1. Referred to the discrete frequency ramp m₂(t), the frequency is applied stably for a period of time τₐ_{_{—}}_{d} before the emission pulse and for a period of time τₐ_{_{—}}ₙ after the emission pulse, the period of time τₐ_{_{—}}ₒₙ corresponding to the emission pulse length. As can be seen from the curves for the sample signal s(t) for the high-frequency sample cycle and from the trigger signal u(t: for analog-digital conversion, said signals have a delay with respect to the power clock a(t) in order to reduce overlapping and glitch effects. The following therefore applies to the representation according to FIG. 4: τₛ_{_{—}}_{d}>τₐ_{_{—}}_{d}, τₛ_{_{—}}ₙ>τₐ_{_{—}}ₙ, τᵤ_{_{—}}_{d}>τₛ_{_{—}}_{d}, τₛ_{_{—}}_{d}, and τᵤ_{_{—}}ₙ>τₛ_{_{—}}ₙ, τₐ_{_{—}}ₒₙ>τₛ_{_{—}}ₒₙ>τᵤ_{_{—}}ₒₙ applies analogously. By means of preferably parallel shifting of the sample time τₛ_{_{—}}ₒₙ and of the trigger signal for the analog-digital converter τᵤ_{_{—}}ₒₙ, where applicable also beyond the limit of the emission pulse length τₐ_{_{—}}ₒₙ, it is additionally possible to influence the respective measuring range.

FIG. 5 shows a simple embodiment of a drive circuit for the. sample and hold circuit in the form of an RC variant. The sample signal s(t) is routed to a Schmitt trigger 28 whose output is connected via a resistor R to the input of a comparator 30. The input of the comparator 30 is furthermore connected to a plurality of capacitors C₁, C₂ to Cₙ to which can in each case be routed a corresponding control signal c₁(t), c₂(t) to cₙ(t) in, for example, the manner explained later in more detail with the aid of FIG. 7. As a function of the control signals c₁(t), c₂(t) to cₙ(t), the comparator 30 supplies an output signal k(t) with different pulse lengths. The output signal k(t) of the comparator 30 is routed to a FET or a diode switch 32 to whose input'the mixer output signal i(t) is applied. The sampled-mixer output signal iₛ(t) is thus applied to the output of the FET or diode switch 32 connected to ground via a capacitor Cₛ.

FIG. 6 shows a simple embodiment of a drive circuit for the sample and hold circuit in the form of a CR variant. The circuit according to FIG. 6 differs from that shown in FIG. 5 only in that the output of the Schmitt trigger 28 is connected via a capacitor C to the input of the comparator 30 which is furthermore connected to a plurality of resistors R₁, R₂ to Rₙ to which are routed the respective control signals c₁(t), c₂(t) to cₙ(t). Reference is otherwise made to the explanations relating to FIG. 5.

FIG. 7 shows a possible association with a variation in pulse duration produced as a function of several control signals. It can be seen here that pulses of different length are produced for the output signal k(t) of the comparator 31) as a function of the control signals c₁(t) and c₂(t) and as a function of the respective RC time constant τ₁, τ₂ or τ₁₇. The duration of the pulse here becomes shorter as the time constant increases. Attention is drawn to the fact that the power clock a(t) can be generated in a fashion identical or similar to the output signal of the comparator 30.

FIG. 8a shows the influence of the sampling gate time on the signal amplitude for two targets spaced approximately 8.4 m apart, with the closer target being approximately 2 m distant, FIG. 8b shows the influence of the sampling gate time on the signal amplitude for two targets spaced approximately 8.4 m apart, with the closer target being approximately 4.5 m distant, FIG. 8c shows the influence of the sampling gate time on the signal amplitude for two targets spaced approximately 8.4 m apart, with the closer target being approximately 4.5 m distant, and FIG. 8d shows the influence of the sampling gate time on the signal amplitude or two targets spaced approximately 8.4 m apart, with the closer target being approximately 6 m distant. The dashed curve corresponds to a sampling gate time τₛ_{_{—}}ₒₙ of 200 ns, while the dotted curve corresponds to a sampling gate time τₛ_{_{—}}ₒₙ of 60 ns. What is shown is the influence of the emission pulse length τₐ_{_{—}}ₒₙ of the power clock a(t) on the achievable measuring range for two different pulse lengths. Two point reflectors (corner reflectors) were arranged approximately 8.4 m apart for this purpose and the measurement then performed for different distances. An effective maximum measuring range of approximately 10 m corresponds to a pulse length of 60 ns, meaning that targets further than 10 m away are highly attenuated in their receive amplitude. By contrast, practically no attenuation occurs up to this value for a pulse length of 200 n, corresponding to an effective maximum measuring range of approximately 33 m. It can be precisely seen in the representation that up to approximately 10 m there is no difference yet in the signal amplitude between the 60-ns and 20-ns power clock pulse. Upward of approximately 12 m a significant reduction in the signal amplitude compared to 60 ns is already discernible which at approximately 15 m goes over into the maximum attenuation of approximately 25 dB to the 200-ns power clock pulse. The prior art requires an at least sixth-order filter in order to attain such an attenuation of the 200-ns power clock pulse with a downstream anti-aliasing filter, requiring a high level of circuitry expenditure and expensive components. According to the invention an anti-aliasing filter of said type can be totally dispensed with.

FIG. 9 shows the influence of the sampling gate time on the signal amplitude for a target with a continuously varied distance. The dashed curve corresponds to a sampling gate time τₛ_{_{—}}ₒₙ of 200 ns, while the dotted curve corresponds to a sampling gate time τₛ_{_{—}}ₒₙ of 60 ns. The representation shows the dependency on signal amplitude of a single point target recorded continuously over the distance, for two different emission pulse lengths τₐ_{_{—}}ₒₙ of 60 ns and 200 ns. In this case also attenuation sets in at approximately 9 m, with a maximum attenuation of approximately 20 dB and around 13 m to the 200-ns power clock pulse being discernible.

The features of the invention disclosed in the above description, in the drawings, and in the Claims can be essential for realizing the invention both individually and in any combination.

1. Radar system with an evaluation device (10) which, on the basis of a spectral analysis of a measuring signal (h(t)) formed from an emission signal (T(t)) and a reception signal (R(t)), determines the speed and/or distance of at least one object to be located
characterized in that
means (12) are provided which limit the emission time (τₐ_{_{—}}ₒₙ) of the emission signal (T(t)) to avoid aliasing effects.

2. Radar system according to claim 1
characterized in that
through limiting of the emission time (τₐ_{_{—}}ₒₙ) of the emission signal (T(t)) a pulse-shaped emission signal (T(t)) is generated whose emission pulse length (τₐ_{_{—}}ₒₙ) determines the maximum measuring range.

3. Radar system according to claim 2
characterized in that
the emission pulse length (τₐ_{_{—}}ₒₙ) of the emission signal (T(t)) is variable.

4. Radar system according to claim 2 or 3
characterized in that
to determine the maximum measuring range changing take place between at least two emission pulse lengths (τₐ_{_{—}}ₒₙ)

5. Radar system according to one of the preceding claims
characterized in that
the measuring signal is a digital measuring signal (h(t)).

6. Radar system according to claim 5
characterized in that
the digital measuring signal (h(t)) is obtained from a mixer out-put signal (i(t)) of a mixer (20).

7. Radar system according to claim 6
characterized in that
the digital measuring signal (h(t)) is supplied by an analog-digital converter (14) whose sampling frequency is variable.

8. Radar system according to claim 7
characterized in that
the mixer output signal (i(t)) is buffered by a sample and hold circuit (18) before being routed to the analog-digital converter (14).

9. Radar system according to claim 8
characterized in that
the sample time (τₛ_{_{—}}ₒₙ) of the sample and hold circuit (18) can be set independently of the emission pulse length (τₐ_{_{—}}ₒₙ).

10. Radar system according to claim 8 or 9
characterized in that
the sample time (τₛ_{_{—}}ₒₙ) of the sample and hold circuit (18) is delayed with respect to the emission pulse length (τₐ_{_{—}}ₒₙ).

11. Radar system according to one of the claims 8 to 10
characterized in that
the sample time (τₛ_{_{—}}ₒₙ) of the sample and hold circuit (18) is less than or the same as the emission pulse length (τₐ_{_{—}}ₒₙ).

12. Radar system according to one of the claims 8 to 11
characterized in that
the input of the sample and hold circuit (18) is taken outside the sample time (τₐ_{_{—}}ₒₙ) to a low-resistance operating point.

13. Radar system according to one of the preceding claims
characterized in that
the emission signal is a frequency-modulated emission signal (T(t)).

14. Radar system according to claim 13
characterized in that
the frequency of the frequency-modulated emission signal (T(t)) is varied at least at times, in particular for determining the distance from an object to be located.

15. Radar system according to claim 13 or 14
characterized in that
the frequency of the frequency-modulated emission signal (T(t)) is continuously varied.

16. Radar system according to claim 13 or 14
characterized in that
the frequency of the frequency-modulated emission signal (T(t)) is varied in discrete frequency stages.

17. Radar system according to claim 16
characterized in that
the discrete frequency stages can be started up in any sequence.

18. Radar system according to claim 13
characterized in that
the frequency of the frequency-modulated emission signal (T(t)) is kept constant at least at times, in particular for determining the speed of an object to be located.

19. Radar system according to one of the preceding claims
characterized in that
the settable emission time (τₐ_{_{—}}ₒₙ) is matched to measuring ranges required in the area of motorized vehicles and is in particular between 20 ns and 200 ns.
